(19) United States
(12) Patent Application Publication
(10) Pub. No.: US 2014/0125624 A1
(43) Pub. Date: May 8, 2014

(54) TOUCH SCREEN PANEL AND PORTABLE ELECTRONIC APPARATUS HAVING THE SAME

(71) Applicant: SAMSUNG ELECTRO-MECHANICS CO., LTD., Suwon (KR)

(72) Inventors: Jae Chan Park, Suwon (KR); Youn Soo Kim, Suwon (KR); Ho Joon Park, Suwon (KR)

(73) Assignee: SAMSUNG ELECTRO-MECHANICS CO., LTD., Suwon (KR)

(21) Appl. No.: 13/854,664

(22) Filed: Apr. 1, 2013

(30) Foreign Application Priority Data
Nov. 2, 2012 (KR) 10-2012-0123674

(51) Int. Cl. G06F 3/041

(52) U.S. Cl. CPC G06F 3/041
USPC 345/174

(57) ABSTRACT

Disclosed herein are a touch screen panel and a portable electronic apparatus having the same. The touch screen panel includes: a cover layer having an outer surface touched by a touch unit and an inner surface, which is an opposite surface to the outer surface; a first scattering layer formed on an inner surface of the cover layer to scatter light passing through the cover layer; an electrode pattern spaced apart from the first scattering layer and formed as a predetermined fine pattern so that capacitance around a touch point at which the touch unit touches the outer surface is changed; and a second scattering layer formed between the first scattering layer and the electrode pattern to scatter light.

### CROSS REFERENCE TO RELATED APPLICATION

This application claims the benefit of Korean Patent Application No. 10-2012-0123674, filed on Nov. 2, 2012, entitled “Touch Screen Panel and Portable Electronic Apparatus Having the Same”, which is hereby incorporated by reference in its entirety into this application.

### BACKGROUND OF THE INVENTION

1. Technical Field

The present invention relates to a touch screen panel and a portable electronic apparatus having the same.

2. Description of the Related Art

In accordance with the growth of computers using a digital technology, devices assisting computers have also been developed, and personal computers, portable transmitters and other personal information processors execute processing of text and graphics using various input devices such as a keyboard and a mouse.

In accordance with the rapid advancement of an information-oriented society, the use of computers has more and more been widened; however, it is difficult to efficiently operate products using only a keyboard and a mouse currently serving as an input device. Therefore, the necessity for a device that is simple, has less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the image display device.

Meanwhile, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

In this touch panel, an electrode pattern is generally made of an indium tin oxide (ITO). However, the ITO has low electrical conductivity and is expensive since indium used as a raw material thereof is a rare earth metal. In addition, the indium is expected to be depleted within the next decade, such that it may not be smoothly supplied. In addition, the electrode pattern of the ITO has low durability in that brittle fracture is easily generated.

For the above-mentioned reason, US patent Laid-Open Publication No. 20100007619 entitled “Touch Panel, Liquid Crystal Display Screen Using the Same, and Methods for Making the Touch Panel and the Liquid Crystal Display Screen” and filed on Jul. 2, 2009, has disclosed a structure in which an electrode is formed using a carbon nano tube.

However, the carbon nano tube is also expensive. In addition, at the time of forming an electrode pattern using the carbon nano tube, very high precision is required, such that a manufacturing cost increases. Therefore, it is advantageous in view of a manufacturing cost to form an electrode pattern using a relatively cheap metal. However, in the case of using a metal electrode pattern, light is reflected on a metal in a touch screen panel, such that the metal electrode pattern is visually recognized by a user.

Therefore, a technology of allowing the metal electrode pattern not to be visually recognized at the outside in spite of using the metal electrode pattern has been urgently demanded.

### PRIOR ART DOCUMENT

### Patent Document

(Patent Document 1) US Patent Laid-open Publication No. 20100007619: “Touch Panel, Liquid Crystal Display Screen Using the Same, and Methods for Making the Touch Panel and the Liquid Crystal Display Screen”

### SUMMARY OF THE INVENTION

The present invention has been made in an effort to provide a touch screen panel allowing an electrode pattern not to be visually recognized at the outside in spite of forming the electrode pattern using a cheap metal material.

Further, the present invention has been made in an effort to provide a portable electronic apparatus capable of increasing a resolution of a display recognized by a user since an electrode pattern is not visually recognized at the outside.

According to a preferred embodiment of the present invention, there is provided a touch screen panel including: a cover layer having an outer surface touched by a touch unit; a first scattering layer formed on an inner surface of the cover layer to scatter light passing through the cover layer; an electrode pattern spaced apart from the first scattering layer and detecting a capacitance change at a touch point at which the touch unit touches the outer surface; and a second scattering layer formed between the first scattering layer and the electrode pattern to scatter light.

At least one surface of the first or second scattering layer may be formed as a rough surface.

The electrode pattern may include first and second electrode patterns disposed to be spaced apart from each other, and the second scattering layer may be formed to scatter light reflected on the first or second electrode pattern.

The touch screen panel may further include a transparent substrate disposed to be adjacent to the first scattering layer, wherein the first and second electrode patterns are formed on both surfaces of the transparent substrate, respectively.

The touch screen panel may further include first and second transparent substrates sequentially disposed from the first scattering layer, wherein the first and second electrode patterns are formed on the first and second transparent substrates, respectively.

The touch screen panel may further include a protection layer protecting the cover layer.

The protection layer may include a hard coating layer.

The hard coating layer may be made of any one of acrylic, epoxy, and urethane, or a combination thereof.

The touch screen panel may further include a wiring connected to the electrode pattern; and a controlling unit detecting the touch point based on a signal received from the wiring.

The scattering layer may be made of a polycrystalline transparent material.

The scattering layer may be made of SiO₂ or SiN.

According to another preferred embodiment of the present invention, there is provided a portable electronic apparatus including: a touch screen panel detecting a touch point touched by a touch unit; a processor receiving an output signal from the touch screen panel to interpret a user input and performing an operation according to the interpreted user input; and a display controlled by the processor, wherein the touch screen panel includes: a cover layer having an outer surface touched by the touch unit; a first scattering layer formed on an inner surface of the cover layer to scatter light passing through the cover layer; an electrode pattern spaced apart from the first scattering layer and detecting a capacitance change at a touch point at which the touch unit touches the outer surface; and a second scattering layer formed between the first scattering layer and the electrode pattern to scatter light.

At least one surface of the first or second scattering layer may be formed as a rough surface.

The electrode pattern may include first and second electrode patterns disposed to be spaced apart from each other, and the second scattering layer may be formed to scatter light reflected on the first or second electrode pattern.

The touch screen panel may further include a transparent substrate disposed to be adjacent to the first scattering layer, wherein the first and second electrode patterns are formed on both surfaces of the transparent substrate, respectively.

The touch screen panel may further include first and second transparent substrates sequentially disposed from the first scattering layer, wherein the first and second electrode patterns are formed on the first and second transparent substrates, respectively.

The touch screen panel may further include a protection layer protecting the cover layer.

The protection layer may include a hard coating layer.

The hard coating layer may be made of any one of acrylic, epoxy, and urethane, or a combination thereof.

The touch screen panel may further include: a wiring connected to the electrode pattern; and a controlling unit detecting the touch point based on a signal received from the wiring.

The scattering layer may be made of a polycrystalline transparent material.

The scattering layer may be made of SiO₂ or SiN.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are cross-sectional views of a touch screen panel according to first and second preferred embodiment of the present invention;

FIGS. 2A and 2B are cross-sectional views of a touch screen panel according to third and fourth preferred embodiment of the present invention;

FIGS. 3A and 3B are plan views in which a cover glass is removed from the touch screen panel shown in FIGS. 2A and 2B;

FIGS. 4A and 4B are cross-sectional views of a touch screen panel according to fifth and sixth preferred embodiment of the present invention;

FIG. 5 is a view showing a process in which light incident from the outside is scattered in the touch screen panel according to the first preferred embodiment of the present invention; and

FIG. 6 is an enlarged view of a touch screen panel embedded in a portable electronic apparatus according to a seventh preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

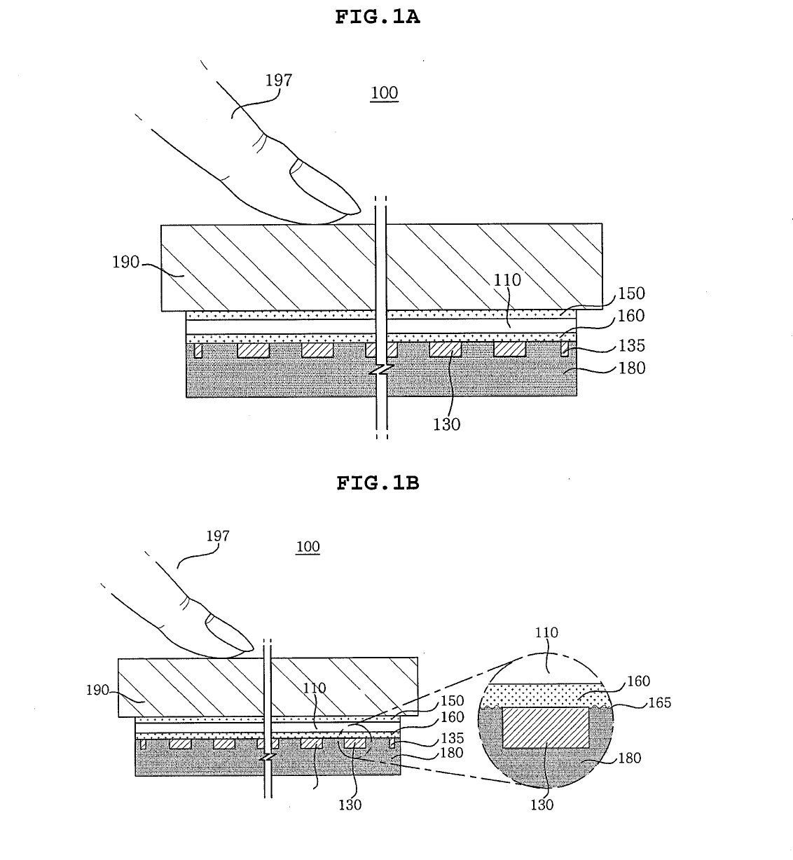

FIGS. 1A and 1B are cross-sectional views of a touch screen panel according to first and second preferred embodiment of the present invention.

Referring to FIG. 1A, the touch screen panel 100 according to the first preferred embodiment of the present invention is configured to include a cover layer 190, first and second scattering layers 150 and 160, a first transparent substrate 110, an electrode pattern 130, and an adhesive layer 180.

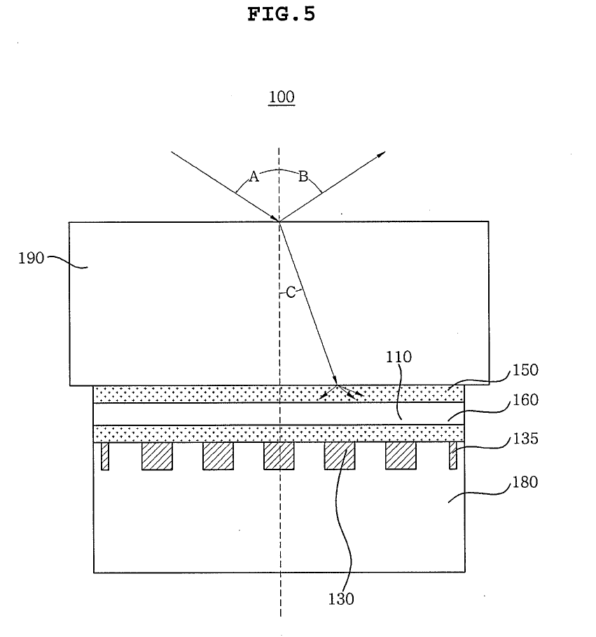

As shown in FIG. 1A, an outer surface, which is an upper portion of the cover layer 190, is touched by a touch unit 197. In addition, an inner surface, which is a lower portion of the cover layer 190 is provided with the first scattering layer 150. The first scattering layer 150 primarily scatters light incident from the outside of the cover layer 190. Therefore, light reflected from the electrode pattern 130 is scattered. A process in which the light is scattered in the first scattering layer 150 will be described below with reference to FIG. 5.

The first transparent substrate 110 is a support serving to provide a region in which the electrode pattern 130 and an electrode wiring 135 are to be formed. Here, the first transparent substrate 110 needs to have support force capable of supporting the electrode patterns 130 and transparency capable of allowing the user to recognize the image provided by an image display device. In consideration of the support force and the transparency described above, the first transparent substrate 110 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like, but is not necessarily limited thereto.

After the first transparent substrate 110 is formed on the first scattering layer 150, the second scattering layer 160 is formed on the first transparent substrate 110. Light passing through the first scattering layer 150 in the light incident from the outside is scattered once more in the second scattering layer 160. In addition, light reflected on the electrode pattern 130 is again scattered while sequentially passing through the second scattering layer 160 and the first scattering layer 150. Therefore, the electrode pattern 130 is not recognized at the outside.

The adhesive layer 180 serves to adhere the touch screen panel 100 to a display device (not shown).

In FIG. 1A, the electrode pattern 130 may be formed as a mesh pattern on one surface of the first transparent substrate 110. However, a scheme of forming the electrode pattern is not limited thereto, and will be described below.

Next, referring to FIG. 1B, the touch screen panel 100 according to the second preferred embodiment of the present invention is configured to include a cover layer 190, first and second scattering layers 150 and 160, a first transparent substrate 110, an electrode pattern 130, and an adhesive layer 180. In the present specification, similar members will be denoted by similar reference numerals. In addition, for simplification of the specification, an overlapped description of the same component will be omitted in the present specification.

Components of the touch screen panel shown in FIG. 1B are similar to those of the touch screen panel shown in FIG. 1A except for the second scattering layer 160. In the second scattering layer 160 shown in FIG. 1B, a first surface 165 contacting the electrode pattern 130 is formed as a rough surface. Although the case in which only the first surface 165 of the second scattering layer 160 is formed as the rough surface is shown in FIG. 1B, the present invention is not limited thereto. Rather, an opposite surface to the first surface 165 may be formed as the rough surface or both surfaces of the second scattering layer 160 may be formed as the rough surface. Furthermore, one surface and the other surface of the first scattering layer 150 as well as the second scattering layer 160 may also be formed as the rough surface.

Referring to FIG. 1B, light is scattered while passing through the first and second scattering layers 150 and 160. However, the entire light is not scattered. That is, there may still be light passing through the scattering layers. However, in the case in which the scattering layer has the rough surface, the passed light is not constantly refracted on a contact surface between the scattering layer and a layer adjacent thereto. Therefore, it is possible to prevent the passed light from arriving at the electrode pattern 130, and it is possible to further prevent the light reflected on the electrode pattern 130 from passing through the cover layer 190.

In FIGS. 1A and 1B, it is preferable that the touch screen panel 100 has transmissivity of 85% or more so that a user may recognize an image provided by an image display device included in a portable electronic apparatus. In addition, it is preferable that the electrode pattern 130 is adjusted to have an aperture ratio of 95% or more in order to implement the transmissivity of the touch screen panel 100 of 85% or more.

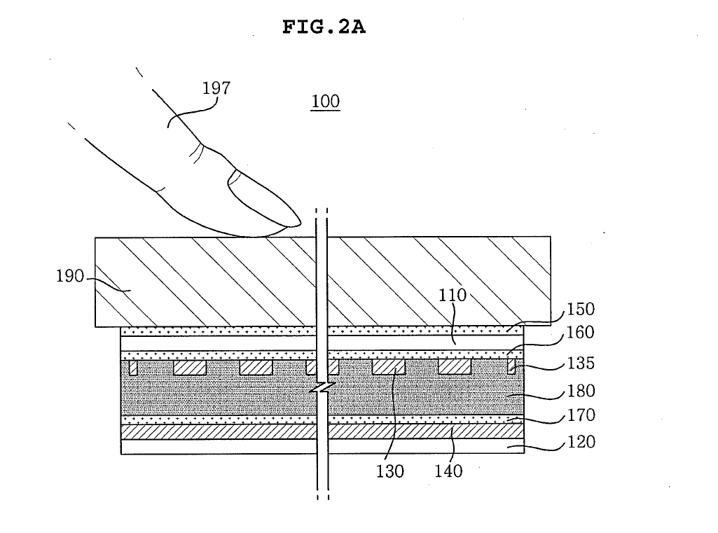

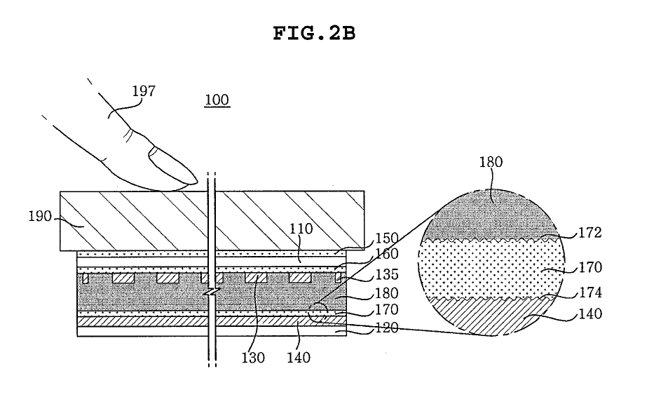

FIGS. 2A and 2B are cross-sectional views of a touch screen panel according to third and fourth preferred embodiment of the present invention.

Referring to FIG. 2A, the touch screen panel 100 according to the third preferred embodiment of the present invention is configured to include a cover layer 190, first to third scattering layers 150, 160 and 170, first and second transparent substrates 110 and 120, first and second electrode patterns 130 and 140, and an adhesive layer 180.

As shown in FIG. 2A, an inner surface, which is a lower portion of the cover layer 190 is provided with the first scattering layer 150. The first scattering layer 150 scatters light incident from the outside of the cover layer 190 and light reflected from the first electrode pattern 130.

The touch screen panel shown in FIG. 2A includes two transparent substrates 110 and 120 and three scattering layers 150, 160, and 170 unlike the touch screen panel shown in FIG. 1A. The first electrode pattern 130 is formed on one surface of the first transparent substrate 110, and the second electrode pattern 140 is formed on one surface of the second transparent substrate 120. In addition, the first and second transparent substrates 110 and 120 each having the above-mentioned electrode patterns formed thereon contact each other by the adhesive layer 180 as shown in FIG. 2A.

As described above, the touch screen panel shown in FIG. 2A may be used as a self-capacitive type touch screen panel or a mutual capacitive type touch screen panel since the first and second electrode patterns 130 and 140 are spaced from each other.

Again referring to FIG. 2A, the second scattering layer 160 is formed on the first electrode pattern 130, and the third scattering layer 170 is formed on the second electrode pattern 140. Therefore, light reflected on the first and second electrode patterns 130 and 140 is scattered in the scattering layers formed on the respective electrode patterns and is again scattered in the first scattering layer. As a result, it is possible to prevent the light reflected on the first and second electrode patterns 130 and 140 from being discharged to the outside of the cover layer 190 to thereby be visually recognized by the user.

Next, referring to FIG. 2B, the touch screen panel 100 according to the fourth preferred embodiment of the present invention is configured to include a cover layer 190, first to third scattering layers 150, 160 and 170, first and second transparent substrates 110 and 120, first and second electrode patterns 130 and 140, and an adhesive layer 180.

Components of the touch screen panel shown in FIG. 2B are similar to those of the touch screen panel shown in FIG. 2A except for the third scattering layer 170. In the third scattering layer 170 shown in FIG. 2B, both of a first surface 174 contacting the second electrode pattern 140 and a second surface 172 contacting the adhesive layer 180 are formed as a rough surface. Although the case in which both surfaces 172 and 174 of the third scattering layer 170 are formed as the rough surface is shown in FIG. 2B, the present invention is not limited thereto. Rather, only any one surface of the third scattering layer 170 may also be formed as the rough surface.

Referring to FIG. 2B, light is scattered while passing through the first and second scattering layers 150 and 160. Further, the light passing through the first and second scattering layers 150 and 160 is scattered once again by the third scattering layer 170 before it arrives at the second electrode pattern 140. In addition, the light reflected on the second electrode pattern 140 is again scattered while sequentially passing through the third scattering layer 170, the second scattering layer 160, and the first scattering layer 150. In addition, since the third scattering layer 170 has the rough surfaces, the passed light is not constantly refracted on a contact surface between the scattering layer and a layer adjacent thereto.

Therefore, it is possible to prevent the passed light from arriving at the second electrode pattern 140, and it is possible to further prevent the light reflected on the second electrode pattern 140 from passing through the cover layer 190.

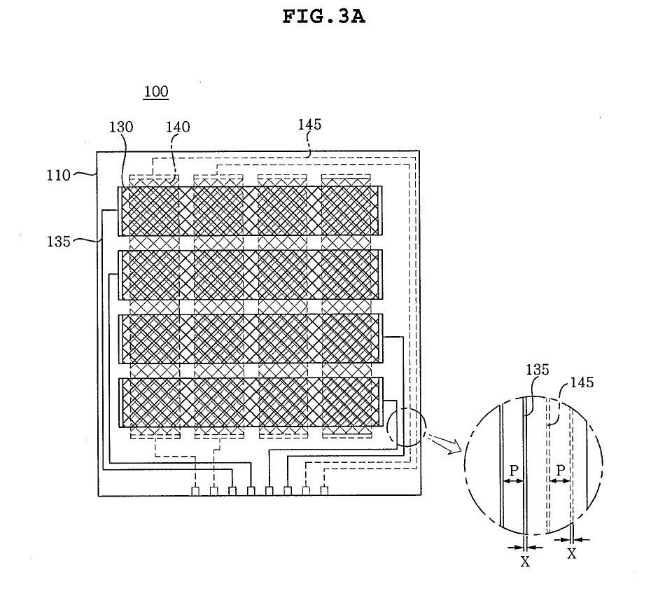

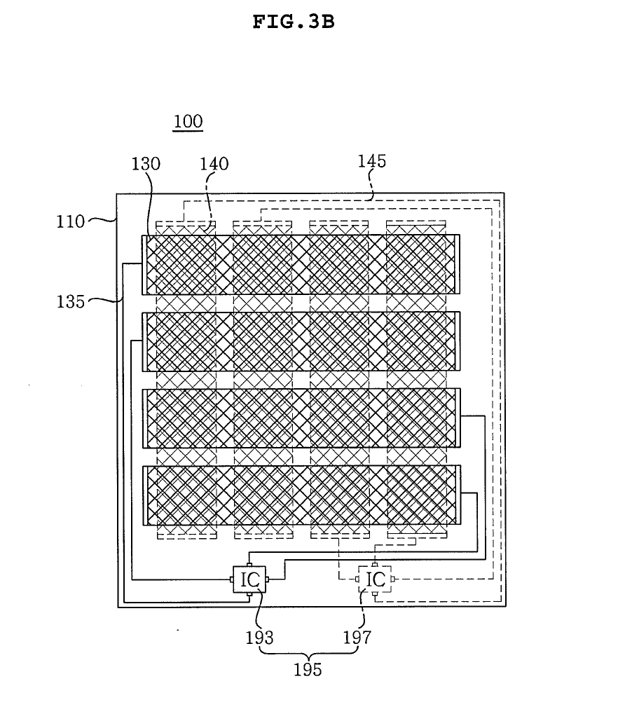

In FIGS. 2A and 2B, the first and second electrode patterns 130 and 140, which generate signals at the time of being touched by the user to serve to allow a touch coordinate to be recognized, are formed on the first and second transparent substrates 110 and 120, respectively. Fine patterns of the first and second electrodes 130 and 140 will be described below with reference to FIGS. 3A and 3B.

FIGS. 3A and 3B are plan views in which a cover glass is removed from the touch screen panel shown in FIGS. 2A and 2B.

First and second wirings 135 and 145, which are connected to the first and second electrode patterns 130 and 140, respectively, to serve to receive electrical signals, is formed on the same plane as a plane on which the first and second electrode patterns 130 and 140 are formed, respectively.

Here, the first wiring 135 may be formed integrally with the first electrode pattern 130, and the second wiring 145 may be formed integrally with the second electrode pattern 140. As described above, the first wiring 135 is formed integrally with the first electrode pattern 130, and the second wiring 145 is formed integrally with the second electrode pattern 140, thereby making it possible to simplify a manufacturing process and decrease a lead time.

In addition, since a bonding process between the first and second wirings 135 and 145 and the first and second electrode patterns 130 and 140 may be omitted, problems such as step generation or a bonding defect between the first and second wirings 135 and 145 and the first and second electrode patterns 130 and 140 may be prevented in advance. However, the first and second wirings 135 and 145 are not necessarily formed integrally with the first and second electrode patterns 130 and 140, but may also be formed separately from the first and second electrode patterns 130 and 140 using a conductive polymer, a carbon black (including a carbon nano tube), a metal oxide, metals, or the like.

Meanwhile, sheet resistance of the first electrode pattern 130 or sheet resistance of the second electrode pattern 140 may become 150 Ω/cm² or less by adjusting a thickness of the electrode pattern or adjusting a material of the electrode pattern so as to be appropriate for the touch screen panel 100. More specifically, the sheet resistance of the first and second electrode patterns 130 and 140 may be 0.1 to 50 Ω/cm². However, this numerical value is provided for illustrative purpose. Therefore, the sheet resistance of the first and second electrode patterns 130 and 140 is not necessarily limited to the above-mentioned numerical value.

It is preferable that a line width W of fine patterns of the first and second electrode patterns 130 and 140 is 3 μm or more in order to prevent the sheet resistance from becoming excessively high and is 7 μm or less in order to prevent the electrode pattern from being visually recognized by the user. As a result, the line width W of the fine patterns of the first and second electrode patterns 130 and 140 is, preferably, 3 to 7 μm, but is not necessarily limited thereto.

In addition, the fine pattern of the first electrode pattern 130 and the fine pattern of the second electrode pattern 140 may have a mesh structure in which rectangles, rhombuses, circles, or ovals are repeated. That is, both of the fine patterns of the first and second electrode patterns 130 and 140 may have the mesh structure in which they intersect with each other as a lattice pattern. Meanwhile, as shown in an enlarged view of FIG. 3A, a line width X and a pitch P (an interval between wirings adjacent to each other) of each of the first and second wirings 135 and 145 may be 50 μm or less, respectively. In addition, the first and second electrode patterns 130 and 140 may be patterned as various patterns such as a bar type pattern, a tooth type pattern, a diamond type pattern, or the like.

In the case in which the first and second electrode patterns 130 and 140 are patterned as the bar type pattern, they may be formed in directions perpendicular to each other. In addition, if necessary, any one of the first and second electrode patterns 130 and 140 may be patterned as a bar type pattern having a relatively wide width, and the other thereof may be patterned as a bar type pattern having a relatively narrow width.

Further, in the case in which the first and second electrode patterns 130 and 140 are patterned as the tooth type pattern, they may be formed of various triangles that are in parallel with each other in one direction. In addition, the first electrode patterns 130 may be configured to be inserted between the second electrode patterns 140 and the second electrode patterns 140 may be configured to be inserted between the first electrode patterns 130 so that the first and second electrode patterns 130 and 140 are not overlapped with each other.

Further, in the case in which the first and second electrode patterns 130 and 140 are patterned as the diamond type pattern, they may be configured of a sensing part (not shown) and a connecting part (not shown), respectively, and be connected to each other through the connecting part in directions perpendicular to each other. In addition, the sensing part of the first electrode pattern 130 and the sensing part of the second electrode pattern 140 may be disposed so as not to be overlapped with each other.

However, as described above, the first and second electrode patterns 130 and 140 are patterned as the bar type pattern, the tooth type pattern, or the diamond type pattern, which is illustrative rather than restrictive. Therefore, the first and second electrode patterns 130 and 140 may be patterned as all patterns known in the art.

In addition, a thickness of the first electrode pattern 130 or a thickness of the second electrode pattern 140 is not particularly limited, but may be 10 μm or less in order to secure appropriate transmissivity. It is more advantageous in securing appropriate transmissivity that the thickness of the first electrode pattern 130 or the thickness of the second electrode pattern 140 is 2 μm or less.

Additionally, as shown in FIG. 3B, the transparent substrate 110 may be provided with a controlling unit 195, which is a kind of controller. Here, the first and second wirings 135 and 145 are directly connected to the controlling unit 195 provided on the transparent substrate 110. As described above, since the first and second wirings 135 and 145 are directly connected to the controlling unit 195 provided on the transparent substrate 110, a flexible printed circuit board according to the prior art may be omitted. For example, the controlling unit 195 may include a first controlling unit 193 provided on one surface of the transparent substrate 110 and a second controlling unit 197 provided on the other surface of the transparent substrate 110. Here, the first wiring 135 is connected to the first controlling unit 193, and the second wiring 145 is connected to the second controlling unit 197.

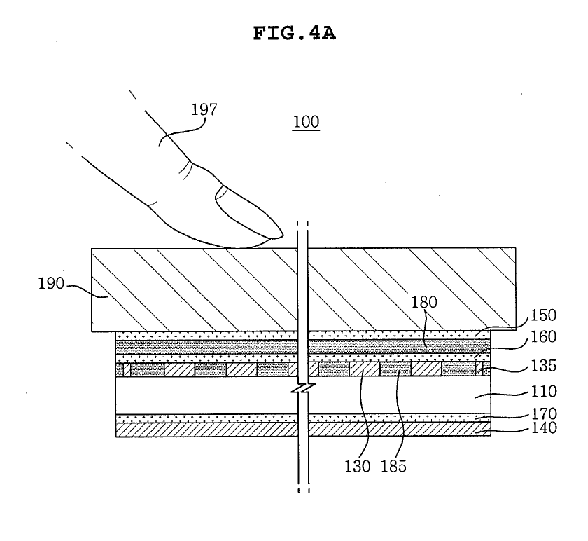

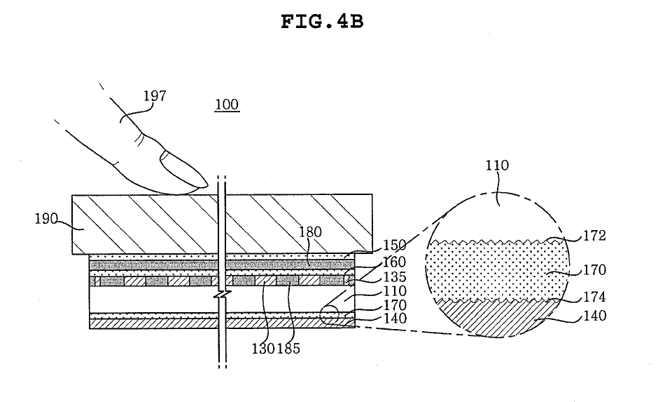

FIGS. 4A and 4B are cross-sectional views of a touch screen panel according to fifth and sixth preferred embodiment of the present invention.

Referring to FIG. 4A, the touch screen panel 100 according to the fifth preferred embodiment of the present invention is configured to include a cover layer 190, first to third scattering layers 150, 160 and 170, a transparent substrate 110, first and second electrode patterns 130 and 140, and first and second adhesive layers 180 and 185.

As described above, the first scattering layer 150 formed on a lower portion of the cover layer 190 scatters light incident from the outside of the cover layer 190 and light reflected from the first and second electrode patterns 130 and 140.

The touch screen panel shown in FIG. 4A includes one transparent substrate 110 and two adhesive layers 180 and 185 unlike the touch screen panel shown in FIG. 2A. The first adhesive layer 180 is formed between the first and second scattering layers 150 and 160, and the second adhesive layer 185 is formed between the second scattering layer 160 and the transparent substrate 110. Particularly, the second adhesive layer 185 helps to allow the second scattering layer 160 and the first electrode 130 or the first adhesive layer 180 and the transparent substrate 110 to contact each other.

In FIG. 4A, the first and second electrode patterns 130 and 140 are formed on both surfaces of the transparent substrate 110, respectively. The first electrode pattern 130 is formed on an upper surface of the transparent substrate 110, and the second electrode pattern 140 is formed on a lower surface of the transparent substrate 110. Here, the second and third scattering layers 160 and 170 are formed on the first and second electrode patterns 130 and 140, respectively. Therefore, light reflected on the first and second electrode patterns 130 and 140 is scattered in the scattering layers formed on the respective electrode patterns and is again scattered in the first scattering layer. As a result, it is possible to prevent the light reflected on the first and second electrode patterns 130 and 140 from being discharged to the outside of the cover layer 190 to thereby be visually recognized by the user.

Next, referring to FIG. 4B, the touch screen panel 100 according to the sixth preferred embodiment of the present invention is configured to include a cover layer 190, first to third scattering layers 150, 160 and 170, a transparent substrate 110, first and second electrode patterns 130 and 140, and first and second adhesive layers 180 and 185.

Components of the touch screen panel shown in FIG. 4B are similar to those of the touch screen panel shown in FIG. 4A except for the third scattering layer 170. In the third scattering layer 170 shown in FIG. 4B, both of a first surface 174 contacting the second electrode pattern 140 and a second surface 172 contacting the transparent substrate 110 are formed as a rough surface. Although the case in which both surfaces 172 and 174 of the third scattering layer 170 are formed as the rough surface is shown in FIG. 4B, the present invention is not limited thereto. Rather, only any one surface of the third scattering layer 170 may also be formed as the rough surface.

Referring to FIG. 4B, light is scattered while passing through the first and second scattering layers 150 and 160. Further, the light passing through the first and second scattering layers 150 and 160 is scattered once again by the third scattering layer 170 before it arrives at the second electrode pattern 140. In addition, the light reflected on the second electrode pattern 140 is again scattered while sequentially passing through the third scattering layer 170, the second scattering layer 160, and the first scattering layer 150. In addition, since the third scattering layer 170 has the rough surfaces, the passed light is not constantly refracted on a contact surface between the scattering layer and a layer adjacent thereto. Therefore, it is possible to prevent the passed light from arriving at the second electrode pattern 140, and it is possible to further prevent the light reflected on the second electrode pattern 140 from passing through the cover layer 190.

FIG. 5 is a view showing a process in which light incident from the outside is scattered in the touch screen panel according to the first preferred embodiment of the present invention. For convenience of explanation, the case in which the light is incident to the touch screen panel 100 shown in FIG. 1A at an incidence angle A is described by way of example. However, it is to be noted that this is provided for illustration, and the present invention is not limited thereto.

In FIG. 5, the touch screen panel 100 includes the cover layer 190, the first and second scattering layers 150 and 160, the transparent substrate 110, the electrode pattern 130, and the adhesive layer 180.

A portion of light incident to the cover layer 190 at an incidence angle A is reflected at a reflection angle B. When a surface of the cover layer 190 is not the rough surface, the incidence angle A is the same as the reflection angle B. In addition, a portion of the incident light is refracted and progresses into the cover layer 190. In this case, a refraction angle C may be determined by a refractive index of the outside of the cover layer 190 and a refractive index of the cover layer 190. For convenience of explanation, it is assumed that the refractive index of air of the outside of the cover layer 190 is 1.003 and the refractive index of the cover layer 190 is 1.5. It is obvious that this does not limit the present invention.

In this case, the refraction angle C is smaller than the incidence angle A. As described above, refractive light passing through the cover layer 190 arrives at a boundary surface between the cover layer 190 and the first scattering layer 150.

However, the first scattering layer 150 includes SiO₂, SiN, or the like, to irregularly scatter the incident light.

Therefore, the incident light arriving at the boundary surface between the cover layer 190 and the first scattering layer 150 is irregularly scattered, such that it has a difficulty in arriving at the first electrode pattern 130. As described above, when the first scattering layer 150 has the rough surface, the light incident to the rough surface will be more irregularly scattered.

In addition, the scattered light arrives at the second scattering layer 160 to thereby be additionally scattered in the second scattering layer 160. Therefore, only a portion of the light incident to the cover layer 190 may arrive at the first electrode pattern 130 and be reflected on the first electrode pattern 130.

In this case, the reflected light is again scattered while passing through the second scattering layer 160, and the light passing through the second scattering layer 160 is additionally scattered while passing through the first scattering. Therefore, finally, only a very small portion of the light incident to the cover layer 190 will be reflected on the first electrode pattern 130 and then discharged to the outside of the cover layer 190. Therefore, it is difficult for the user to visually recognize existence of the first electrode pattern 130.

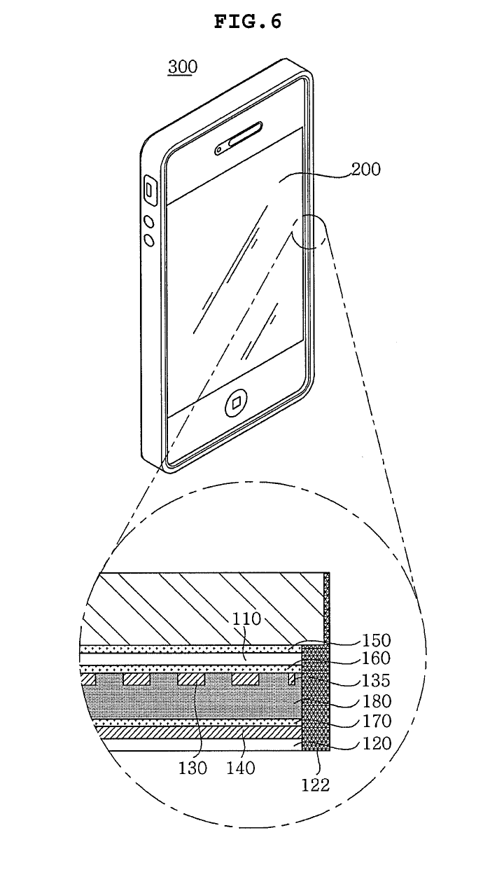

FIG. 6 is an enlarged view of a touch screen panel embedded in a portable electronic apparatus according to a seventh preferred embodiment of the present invention.

FIG. 6 shows a general portable electronic apparatus 300 such as a smart phone or a smart pad. In addition, FIG. 6 shows a cross-sectional view of a touch screen panel configuring a portion of a display 200 included in the portable electronic apparatus 300.

The portable electronic apparatus 300 includes a processor (not shown) receiving an output signal from the touch screen panel to interpret a user input and performing an operation according to the interpreted user input and the display 20 controlled by the processor. The display 200 included in the portable electronic apparatus 300 shown in FIG. 6 includes a touch screen panel sensing a touch by the user.

The portable electronic apparatus 300 may include all electronic apparatuses according to the prior art that may be operated by the touch by the user. Therefore, for simplification of the specification, an additional description of the portable electronic apparatus will be omitted.

Referring to an enlarged cross-sectional view, the touch screen panel included in the portable electronic apparatus 300 includes the cover layer 190, the first and second scattering layers 150 and 160, the first transparent substrate 110, the electrode pattern 130, and the adhesive layer 180. As shown in FIG. 6, the first scattering layer 150 formed on the lower portion of the cover layer scatters the light incident from the outside and the light reflected from the first electrode pattern 130.

In addition, the first electrode pattern 130 is formed on one surface of the first transparent substrate 110, and the second electrode pattern 140 is formed on one surface of the second transparent substrate 120. In addition, the first and second transparent substrates 110 and 120 each having the above-mentioned electrode patterns formed thereon contact each other by the adhesive layer 180 as shown in FIG. 6.

Further, the second scattering layer 160 is formed on the first electrode pattern 130, and the third scattering layer 170 is formed on the second electrode pattern 140. Therefore, light reflected on the first and second electrode patterns 130 and 140 is scattered in the scattering layers formed on the respective electrode patterns and is again scattered in the first scattering layer. As a result, it is possible to prevent the light reflected on the first and second electrode patterns 130 and 140 from being discharged to the outside of the cover layer 190 to thereby be visually recognized by the user.

At least one surface of each of the first to third scattering layers 150, 160, and 170 may be formed as the rough surface to additionally scatter the light, as described above.

In addition, a protection layer (not shown) may be provided on the cover layer. The protection layer, which serves to protect the cover layer, may be formed of, for example, a hard coating layer. Particularly, the hard coating layer may be made of any one of acrylic, epoxy, and urethane, or a combination thereof.

According to the preferred embodiments of the present invention, the scattering layers are formed on the cover glass and the metal electrode pattern to scatter the light reflected on the metal electrode pattern, thereby making it possible to allow the metal electrode pattern not to be visually recognized at the outside.

In addition, according to the preferred embodiments of the present invention, the scattering layer formed on the metal electrode pattern scatters the light reflected on the metal electrode pattern, thereby making it possible to prevent an image output in the display device from being hindered.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch screen panel comprising:
a cover layer having an outer surface touched by a touch unit;
a first scattering layer formed on an inner surface of the cover layer to scatter light passing through the cover layer;
an electrode pattern spaced apart from the first scattering layer and detecting a capacitance change at a touch point at which the touch unit touches the outer surface; and
a second scattering layer formed between the first scattering layer and the electrode pattern to scatter light.

2. The touch screen panel as set forth in claim 1, wherein at least one surface of the first or second scattering layer is formed as a rough surface.

3. The touch screen panel as set forth in claim 1, wherein the electrode pattern includes first and second electrode patterns disposed to be spaced apart from each other, and
the second scattering layer is formed to scatter light reflected on the first or second electrode pattern.

4. The touch screen panel as set forth in claim 3, further comprising a transparent substrate disposed to be adjacent to the first scattering layer,
wherein the first and second electrode patterns are formed on both surfaces of the transparent substrate, respectively.

5. The touch screen panel as set forth in claim 3, further comprising first and second transparent substrates sequentially disposed from the first scattering layer,
wherein the first and second electrode patterns are formed on the first and second transparent substrates, respectively.

6. The touch screen panel as set forth in claim 1, further comprising a protection layer protecting the cover layer.

7. The touch screen panel as set forth in claim 6, wherein the protection layer includes a hard coating layer.

8. The touch screen panel as set forth in claim 7, wherein the hard coating layer is made of any one of acrylic, epoxy, and urethane, or a combination thereof.

9. The touch screen panel as set forth in claim 1, further comprising a wiring connected to the electrode pattern; and
a controlling unit detecting the touch point based on a signal received from the wiring.

10. The touch screen panel as set forth in claim 1, wherein the scattering layer is made of a polycrystalline transparent material.

11. The touch screen panel as set forth in claim 10, wherein the scattering layer is made of SiO₂ or SiN.

12. A portable electronic apparatus comprising:
a touch screen panel detecting a touch point touched by a touch unit;
a processor receiving an output signal from the touch screen panel to interpret a user input and performing an operation according to the interpreted user input; and
a display controlled by the processor,
wherein the touch screen panel includes:
a cover layer having an outer surface touched by the touch unit;
a first scattering layer formed on an inner surface of the cover layer to scatter light passing through the cover layer;
an electrode pattern spaced apart from the first scattering layer and detecting a capacitance change at a touch point at which the touch unit touches the outer surface; and
a second scattering layer formed between the first scattering layer and the electrode pattern to scatter light.

13. The portable electronic apparatus as set forth in claim 12, wherein at least one surface of the first or second scattering layer is formed as a rough surface.

14. The portable electronic apparatus as set forth in claim 12, wherein the electrode pattern includes first and second electrode patterns disposed to be spaced apart from each other, and
the second scattering layer is formed to scatter light reflected on the first or second electrode pattern.

15. The portable electronic apparatus as set forth in claim 14, wherein the touch screen panel further includes a transparent substrate disposed to be adjacent to the first scattering layer,
the first and second electrode patterns being formed on both surfaces of the transparent substrate, respectively.

16. The portable electronic apparatus as set forth in claim 14, wherein the touch screen panel further includes first and second transparent substrates sequentially disposed from the first scattering layer,
the first and second electrode patterns being formed on the first and second transparent substrates, respectively.

17. The portable electronic apparatus as set forth in claim 12, wherein the touch screen panel further includes a protection layer protecting the cover layer.

18. The portable electronic apparatus of claim 17, wherein the protection layer includes a hard coating layer.

19. The portable electronic apparatus as set forth in claim 18, wherein the hard coating layer is made of any one of acrylic, epoxy, and urethane, or a combination thereof.

20. The portable electronic apparatus as set forth in claim 12, wherein the touch screen panel further includes:
a wiring connected to the electrode pattern; and
a controlling unit detecting the touch point based on a signal received from the wiring.

21. The portable electronic apparatus as set forth in claim 12, wherein the scattering layer is made of a polycrystalline transparent material.

22. The portable electronic apparatus as set forth in claim 21, wherein the scattering layer is made of SiO₂ or SiN.
